(19) United States
(12) Patent Application Publication
(10) Pub. No.: US 2023/0169412 A1
(43) Pub. Date: Jun. 1, 2023

(54) EXPERT BOOKING MANAGEMENT SYSTEM

(71) Applicant: EBO, CORP., Baltimore, MD (US)

(72) Inventor: Crystal Ilise Berger, Baltimore, MD (US)

(73) Assignee: EBO, CORP., Baltimore, MD (US)

(21) Appl. No.: 18/059,998

(22) Filed: Nov. 30, 2022

Related U.S. Application Data
(60) Provisional application No. 63/284,147, filed on Nov. 30, 2021.

(51) Int. Cl. G06Q 10/02; G06F 16/9035; G06F 16/908; G06F 16/909

(52) U.S. Cl. CPC G06Q 10/02; G06F 16/9035; G06F 16/908; G06F 16/909

(57) ABSTRACT

The present disclosure relates generally to a computer implemented system comprising at least a database of expert guests organized by a myriad of categories selected from the group consisting of a topic, a news story, an industry, an expertise, and a geographic location. The database includes previous content by the expert guests, wherein the previous content includes audio and video expert reels. The database further includes curated customer playlists tailored to customers based on news climate and news genre, wherein the topic is selected from the group consisting of politics, science, technology, diversity and inclusion, sports, entertainment, and the like. The system and associated processes better facilitate and enable the online booking, scheduling, and/or coordinating of an expert speaker as a guest for media.

### CROSS-REFERENCE TO RELATED APPLICATION

This U.S. Non-Provisional Patent application claims priority to U.S. Provisional Application No. 63/284,147 filed 30 Nov. 2021 to the above named inventor, the disclosure of which is considered part of the disclosure of this application and is hereby incorporated by reference in its entirety.

### FEDERALLY SPONSORED RESEARCH OR DEVELOPMENT

Not Applicable.

### SEQUENCE LISTING, A TABLE, OR A COMPUTER PROGRAM

Not Applicable.

### FIELD OF THE INVENTION

This invention relates generally to a management system and associated process steps for a computer implemented method capable of online booking, scheduling, and coordinating an expert speaker as a guest for a media.

### BACKGROUND

Conventional event management systems typically include features that enable a user (e.g., an event coordinator) to plan an event—e.g., a seminar, conference, or other type of event. For example, EventPro® Planner, available from EventPro Software of Saskatoon, Canada, permits a user to plan logistics of an event such as registration details, travel arrangements, accommodations, communications, budgets, and so on. Likewise, Cvent, available from Cvent, Inc. of McLean, Va., permits a user to plan logistics associated with an event, including: marketing the event through e-mail.

Traditional television programming relies on program content being generated in the broadcast studio or received from a communications satellite, microwave link, landline, or cable from a remote mobile production unit. Producers at a single studio location manipulate the program content to produce television programs, which are broadcast to the viewing audience.

In U.S. Pat. No. 8,286,218, a production facility receives program content from a plurality of broadcast feeds over the Internet. In an embodiment, the production facility comprises a server on a computer network, such as the Internet. The server comprises computer programs configured to manipulate the audio and video data of the multiple program contents. At the production facility, the program content can be manipulated to produce a production. Program manipulation can comprise at least one of green screen technology, music, graphics, Foley, sound effects, voice over and advertising. The production is broadcast over the computer network to viewers, where the viewers receive the production. In an embodiment, the production is customized based on the viewers' input received while broadcasting. In other words, the production is customized in real time based at least in part on the interaction of the production with the viewers. In another embodiment, the viewers can further manipulate the program content of the production to create a new production, which can be broadcast over the customized programming system.

A benefit to customizing production in real time based at least in part on the interaction of the production with the viewers is to acquire an expert speaker as a guest for a media network news program segment based on viewers demographics, location, populated expert suggestions based on area of expertise, automated availability, and previous expert content.

There is currently a significant lack in the use of smart technology and access to diverse perspectives in newsrooms across the nation. There is a need for a system that overcomes barriers to entry in media via the use of smart technology.

There is a need for a system that saves time, money and energy, by eliminating excessive fees, waiting-times and ensuring quality perspectives are booked with ease and efficiency.

There is a need for a system that ensures that newsrooms and nontraditional media platforms are equitable, not just inclusive, by expanding the narrative of today's media landscape in offering fresh, diverse and credible perspectives.

There is also a need for a system that provides a smart and safe platform for media professionals to be social, engage, and to get booked for media appearances.

### BRIEF SUMMARY OF THE INVENTION

In one aspect of the invention, a system for online booking, scheduling, and coordinating an expert speaker as an expert guest for a media is disclosed. This system reduces costs to stations by making publicists more resourceful and expanding their access to reputable broadcast platforms.

The system comprising a database of expert guests organized by a myriad of categories selected from the group consisting of a topic, a news story, an industry, an expertise, and a geographic location. The database includes previous content by the expert guests, wherein the previous content includes audio and video expert reels. The database further includes curated customer playlists tailored to customers based on news climate and news genre, wherein the topic is selected from the group consisting of politics, science, technology, diversity and inclusion, sports, entertainment, and the like. The system includes an expert guest auto-suggest or expert guest search function, wherein either the expert guest auto-suggest or expert guest search function facilitates searches for expert guests, wherein either the expert guest search function includes scroll navigation expert database information. Accordingly, this scroll navigation is optimized for smartphones and tablets, wherein either the expert guest auto-suggest or expert guest search function includes guest availability detection. The system includes an automated expert guest booking online platform, wherein the platform includes user auto-fill wherein searching or selecting an expert guest involves matching the user typed information to the name or identifier of the expert guest, wherein platform populates the typing field with the names or identifiers of the expert guests from the database which match the user's typed information. The system and platform includes autosave for user searches, bookings, or subscription renewals, and expert booking management. The system management feature includes calendar syncing for Google, Outlook or the like, wherein the management includes customizable confirmations, reminders or follow-ups, and wherein the management feature includes newsroom intranet integration.

In a further aspect of the invention, the user is affiliated with a public relations firm, local news station or network.

In a further aspect of the invention, the system is online and available for access through a secure platform that is desktop or mobile device compatible.

In a further aspect of the invention, the system auto-suggests expert guests based upon the system user's browsing history, search queries, and the like.

In a further aspect of the invention, the system analyzes a news story or report and auto-suggests expert guests based on the information included in the news story or report, based upon the system users' or content viewer's demographics and current location, based upon the news content demographics and location.

In a further aspect of the invention, the system analyzes news stories or reports from sources such as the Associated Press, Google News, or the like.

In a further aspect of the invention, the news stories or reports are categorized by geography.

In a further aspect of the invention, the expert guests have been subjected to evaluation or appraisal.

The invention now will be described more fully hereinafter with reference to a more detailed description, which is intended to be read in conjunction with this summary and any preferred and/or particular embodiments specifically discussed or otherwise disclosed. This invention may, however, be embodied in many different forms and should not be construed as limited to the embodiments set forth herein; rather, these embodiments are provided by way of written illustration only and so that this disclosure will be thorough, complete and will fully convey the full scope of the invention to those skilled in the art.

### DETAILED DESCRIPTION OF THE INVENTION

The following detailed description includes references to specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense.

All Appendices, publications, patents and patent applications cited herein, whether supra or infra, are hereby incorporated by reference in their entirety to the same extent as if each individual publication, patent or patent application was specifically and individually indicated to be incorporated by reference. The Appendix is expressly incorporated by reference.

Before the present invention of this disclosure is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the disclosure made herein.

Unless otherwise indicated, the words and phrases presented in this document have their ordinary meanings to one of skill in the art. Such ordinary meanings can be obtained by reference to their use in the art and by reference to general and scientific dictionaries.

References in the specification to “one embodiment” indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following explanations of certain terms are meant to be illustrative rather than exhaustive. These terms have their ordinary meanings given by usage in the art and in addition include the following explanations.

As used herein, the term “and/or” refers to any one of the items, any combination of the items, or all of the items with which this term is associated.

As used herein, the singular forms “a,” “an,” and “the” include plural reference unless the context clearly dictates otherwise.

As used herein, the terms “include,” “for example,” “such as,” and the like are used illustratively and are not intended to limit the present invention.

As used herein, the terms “preferred” and “preferably” refer to embodiments of the invention that may afford certain benefits, under certain circumstances. However, other embodiments may also be preferred, under the same or other circumstances.

As used herein the terms “media” or “medias” refers to radio, television, or the web.

Furthermore, the recitation of one or more preferred embodiments does not imply that other embodiments are not useful and is not intended to exclude other embodiments from the scope of the invention.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element without departing from the teachings of the disclosure.

The expert booking management system of the present disclosure provides a computer implemented method in the form of software and associated process for the automated booking of an expert for booking on a preferred media type. The expert booking system is hosted on a computer storage device, such as, but not limited to a server, accessible via an internet connected device such as desktop or mobile device. The system includes a secured platform allowing access for registered users. The registered user is categorized into the following groups of an expert user, a station user, a publicist user, and an admin user. Each of these user types is generally selected to conform to a user within a given industry, wherein a expert user is generally an individual with media training and talent and a desire to be booked as an expert by a media, a station user is generally a media type that is looking to acquire an expert, a publicist user is generally related a publicist or other similar agent in the form of an individual looking to facilitate the booking of an expert, and an admin user generally related to an administrator having access to all of the other user types of the system. Each of this expert user, station user, publicist user, and admin user must register in the system by providing certain identifying information configured for storage on the database in a manner to uniquely identify each individual registered user of the system. Each of these categories of registered users may be alternate or different fields to collect information for storage in the database and operation of the platform. Accordingly, the publicist user and admin user has the ability to upload and edit a profiles of a given registered user that has been linked to the publicist user or the admin user.

The system and method generally allows the registered user to search the database by a topic, a news story, an industry, or an expertise. The system and associated platform further facilitates the booking or solicits the booking of a given expert online. The experts available for selection have been previously vetted and media trained through a verification process. This verification process is initiated upon the creation of a registered user within the expert category of user. Therefore, a user of the expert booking system can save time, money, and energy. More particularly, the expert booking system enables booking and scheduling and facilitates coordination through notifications and reminders. This system has particular use in visual media as it reduces costs to stations, registered within the category of the station user, by making publicists, registered within the publicist category of user, more resourceful and expanding their access to reputable broadcast platforms.

The system comprises a database of organizing a registered user within the expert user category by a myriad of additional categories selected from the group consisting of a topic, a news story, an industry, an expertise, and a geographic location. The database includes previous content that is uploaded to the database by a registered user for a given registered user, wherein the previous content includes audio and video expert reels in the form of digital video files or audio files. Upon receipt of these files, the system will use an information file generated by registered user submitted data from an upload to create a description of a given expert reel. The information file and data is then utilized by the system to generate automatically a curated customer playlist tailored to a given customer based on news climate and news genre, wherein the topic is selected from the group consisting of politics, science, technology, diversity and inclusion, sports, and entertainment.

The system includes a search function labeled as an expert guest auto-suggest or an expert guest search function, wherein either the expert guest auto-suggest or expert guest search function facilitates the generation of a selected expert for display to user. Accordingly, during the search process, the system will access the database, and display for a user, suggested experts based upon search criteria as it is entered. Additionally, auto-suggest or expert guest search function may access a browsing history, search queries, and the like for a given registered user, wherein the auto-suggest processing steps include recommendations based upon this browsing and search queries history. This expert guest auto-suggest or expert guest search function includes scroll navigation functionality to enable viewing and searching of database information. Accordingly, this scroll navigation is optimized for smartphones and tablets, wherein either the expert guest auto-suggest or expert guest search function includes a guest availability detection function. The guest availability detection function will use entered and selected scheduling data to confirm availability of a given expert.

The system includes an automated expert guest booking online platform coupled to the database and wherein the platform includes a user auto-fill wherein searching or selecting an expert guest involves matching the user typed information to a name or an identifier of a given expert guest. This automated expert guest booking online platform searches the database in real-time to populates a typing field with the names or identifiers of the expert guests having a given profile and stored content in the database which match the user's typed information. The system and platform includes autosave for user searches, bookings, or subscription renewals, and expert booking management. The registered user has access to a system management feature that includes calendar syncing for Google, Outlook or the like, wherein the system management feature includes customizable confirmations, reminders or follow-ups, and wherein the system management feature includes newsroom intranet integration.

The system and method steps are generally conducted in an online environment through a webpage/web portal and is available for access through a secure platform that is desktop or mobile device compatible.

In a further aspect of the invention, the system analyzes a news story or report and auto-suggests expert guests based on the information included in the news story or report, based upon the system users' or content viewer's demographics and current location, based upon the news content demographics and location. These news stories or reports may come from additional and common public sources such as the Associated Press, Google News, or the like. These given reports a categorized by the system according to the geographic location of a given story and stored in the database with a geographic location identifier. Further, as it relates to a geographic location, the system is configured to determine through embedded software the GPS location of a given registered user during use of the system with this location utilized in searching and booking aspects of the system.

The system and method includes integration with video communication software, wherein a registered user may initiate through the system an video call or the like. Accordingly, the system and method is configured with an integrated Zoom API into the platform for all users.

A registered user in the form of a station user has the ability to add or upload a station database of content generated by the station user to the database for integration into the system. Additionally, the station user has an added function in the form of an invite experts function, this function gives the station user the ability to invite experts by generating email invitations non-users to join the platform.

The station user additionally has added functionality with the ability create their own class of user in the form of a super admin, a producer, and a user. Further, the station user has additional search functionality in that they can select to filter search results by a given industry called “filter by industry”. Additionally, for a station user, the station name field is a self-fill and drop-down option, wherein the system adds a newly registered station to the database and menu to enable the drop-down option.

For the expert registered user the system is configured to generate a pop-up menu to provide the expert the ability to comment on trending news as news develops while the expert user is logged in and using the system. Further, the expert user has the ability to add a given expertise to be associated with their registered account and stored in the database as a search criteria. Additionally, to prevent ease of cancellation for a booked expert, an expert user must go through a 4-step process added to cancel a previously accepted booking.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A computer implement system and method for online booking, scheduling, and/or coordinating an expert speaker as a guest for a media, the system comprising executing on a web server the steps of:
creating a registered user within a category of users selected from an expert, a station, a publicist, and an admin user;
storing data associated with each registered user in a database, wherein the data includes audio and video files in the form of reels;
organizing the data within the database into the following categories selected from the group consisting of a topic, a news story, an industry, an expertise, and a geographic location;
curating a customer playlist tailored to the customer based on news climate and news genre, wherein the customer can access and view of the playlist within the system;
providing an expert guest auto-suggest or expert guest search function, wherein either the expert guest auto-suggest or expert guest search function facilitates a user to search for expert guests, wherein either the expert guest search function includes scroll navigation expert database information, wherein the scroll navigation is optimized for smartphones and tablets, wherein either the expert guest auto-suggest or expert guest search function includes guest availability detection; and
providing an expert booking management feature, wherein the management includes calendar syncing for an existing calendar in a device, wherein the management includes customizable confirmations, reminders or follow-ups.

2. A system as in claim 1, wherein the media is radio, television or the web.

3. A system as in claim 1, wherein the system is online and available for access through a secure platform that is desktop or mobile device compatible.

4. A system as in claim 1, wherein the system auto-suggests expert guests based upon the system registered user's browsing history.

5. A system as in claim 1, wherein the system analyzes a news story or a report uploaded to the database and auto-suggests expert guests based on the information included in the news story or report, based upon the system users' or a content viewer's demographics and current location, based upon the news content demographics and location.

6. A system as in claim 5, wherein the system analyzes the news stories or reports from sources such as the Associated Press and Google News.

7. A system as in claim 5, wherein the news stories or reports are categorized by geography.

8. A system as in claim 1, wherein the expert guests are categorized by an evaluation and vetting process.
